(19) United States
(12) Patent Application Publication
(10) Pub. No.: US 2026/0277031 A1
(43) Pub. Date: Sep. 17, 2026

(54) CORNEAL LENS CLEANING MECHANISM

(71) Applicant: Ningbo Kaida Rubber and Plastic Technology Co., Ltd, Yuyao (CN)

(72) Inventor: Liming Hu, Yuyao (CN)

(21) Appl. No.: 19/372,396

(22) Filed: Oct. 29, 2025

(30) Foreign Application Priority Data
Mar. 17, 2025 (CN) 202510311939.8

(51) Int. Cl. G02C 13/00; A46B 5/00; A46B 13/00; A46B 13/02; A46B 17/08; A46D 1/00

(52) U.S. Cl. CPC G02C 13/008; A46B 5/0012; A46B 13/005; A46B 13/02; A46B 17/08; A46D 1/02; A46B 2200/3073

(57) ABSTRACT

The present disclosure discloses a corneal lens cleaning mechanism, including a carrier module configured to place a corneal lens; and a cleaning module, in contact with the corneal lens for cleaning the corneal lens. The carrier module is provided with a plurality of windows for the cleaning module to pass through, and the carrier module and the cleaning module partially overlap, allowing the cleaning module to pass through the windows into the carrier module to be in contact with the corneal lens. The cleaning module is movable relative to the carrier module. When moving, the cleaning module pushes the corneal lens to move in the carrier module, and meanwhile, the cleaning module moves relative to the corneal lens to wipe and clean the surface of the corneal lens. The present disclosure has a good cleaning effect and does not cause damage to the lens.

### CROSS-REFERENCE TO RELATED APPLICATIONS

This application claims priority to CN. Patent Application No. 202510311939.8, filed on Mar. 17, 2025, which is hereby incorporated by reference in its entirety.

### TECHNICAL FIELD

The present disclosure belongs to the technical field of corneal contact lens cleaning, and in particular relates to a corneal lens cleaning mechanism.

### BACKGROUND

Corneal contact lenses include daily-wear contact lenses and orthokeratology lenses. Due to long daily wearing time, the contact lenses constantly come into contact with tears, inevitably leading to the deposition of proteins from the tears on the surface and inside of the lenses, which reduces the oxygen permeability of the lenses and causes dry and uncomfortable eyes, photophobia, and tearing. Protein deposits may also breed bacteria and microorganisms, causing corneal infections or even corneal ulcers, which seriously endangers eye health.

The issue of “difficult and cumbersome cleaning” of the lenses has always troubled every clinical optometrist, parent, and user of the corneal contact lens (RGP, OK lens, scleral lens). The traditional way to clean corneal contact lenses is to rub them with fingers. Many people, due to improper cleaning methods, uneven force on the lens and long fingernails, easily cause cross-contamination of the lenses with bacteria remaining on fingers and under nails. This often leads to scratches and damage to the lenses, severe wear on the lens surface, inadequate cleaning or changes in the optical properties of the lenses.

Currently, there are also devices for cleaning contact lenses in the prior art, but they often have poor cleaning effects and easily cause damage to the lenses.

### SUMMARY

The content of the present disclosure is used to introduce concepts in a brief form, and these concepts will be described in detail in the specific implementations below. The content of the present disclosure is not intended to identify key features or essential features of the claimed technical solution, nor is it intended to limit the scope of the claimed technical solution.

In order to overcome the deficiencies in the prior art, the present disclosure provides a corneal lens cleaning mechanism.

In order to achieve the above-mentioned objective, the present disclosure adopts the following technical solution: a corneal lens cleaning mechanism, including:

a carrier module, configured to place a corneal lens; and

a cleaning module, in contact with the corneal lens for cleaning the corneal lens; where

the carrier module is provided with a plurality of windows for the cleaning module to pass through, and the carrier module and the cleaning module partially overlap, allowing the cleaning module to pass through the windows into the carrier module to be in contact with the corneal lens; and

the cleaning module is movable relative to the carrier module; when moving, the cleaning module pushes the corneal lens to move in the carrier module; and meanwhile, the cleaning module moves relative to the corneal lens to wipe and clean the surface of the corneal lens.

Further, the carrier module includes:

a plurality of baskets, each configured to have a basket structure for placing the corneal lens; and

a cover plate, covering the basket to form an accommodating space on the basket; where

the windows are provided in the basket and the cover plate, to form a plurality of openings for the cleaning module to extend into in side walls of the accommodating space.

Further, the cleaning module includes:

at least one cleaning assembly, configured to clean the corneal lens; and

a support body, configured to install the cleaning assembly; where

the cleaning assembly includes a plurality of bristle portions and a connecting portion, and the bristle portions are connected to the connecting portion;

the bristle portions are each made of a flexible material such that the bristle portion bends when in contact with the cornea lens, allowing a side wall of the bristle portion to be in contact with the cornea lens to clean the cornea lens; and

the connecting portion is made of a flexible material and is connected to the support body.

Further, the bristle portion is of an elongated structure and has a length of 5-15 mm.

Further, a cross-sectional area of the one end of the bristle portion perpendicular to a length direction of the bristle portion is greater than a cross-sectional area of the other end of the bristle portion perpendicular to the length direction of the bristle portion.

Further, a cross-sectional diameter of one end of the bristle portion perpendicular to the length direction of the bristle portion is 1-2.2 mm, and a cross-sectional diameter of the other end of the bristle portion perpendicular to the length direction of the bristle portion is 0.5-1.2 mm.

Further, the bristle portions are evenly arranged on the connecting portion along a length direction of the connecting portion, and a distance between adjacent bristle portions is 2.5-4 mm.

Further, the window has a width of 1-2.2 mm.

Further, the windows are evenly arranged along a side wall of the basket or cover plate, and a distance between two adjacent windows is 2.5-4 mm.

Further, the basket has a depth of 3-8.5 mm.

The benefit of the present disclosure lies in providing a corneal lens cleaning mechanism which has a good cleaning effect and does not cause damage to the lens.

### BRIEF DESCRIPTION OF THE DRAWINGS

The accompanying drawings, which constitute a part of the present disclosure, are used to provide a further understanding of the present disclosure and make other features, objectives and advantages of the present disclosure more apparent. The illustrative embodiment accompanying drawings of the present disclosure and descriptions thereof are used to explain the present disclosure and do not constitute improper limitations on the present disclosure.

In addition, the same or similar reference numerals denote the same or similar elements throughout the accompanying drawings. It should be understood that the accompanying drawings are illustrative and that components and elements are not necessarily drawn to scale.

In the figures:

FIG. 1 is a schematic structural diagram of a corneal lens cleaning mechanism in one embodiment of the present disclosure.

FIG. 2 is a sectional view of the corneal lens cleaning mechanism in the embodiment shown in FIG. 1.

FIG. 3 is a schematic structural diagram of a cleaning module of the corneal lens cleaning mechanism in the embodiment shown in FIG. 1.

FIG. 4 is a schematic diagram of a cleaning assembly of a corneal lens cleaning mechanism in the embodiment shown in FIG. 1.

FIG. 5 is a schematic diagram of a support body of the corneal lens cleaning mechanism in the embodiment shown in FIG. 1.

FIG. 6 is a sectional view of a cleaning assembly of the corneal lens cleaning mechanism in the embodiment shown in FIG. 1.

FIG. 7 is a schematic structural diagram of a carrier module of the corneal lens cleaning mechanism in the embodiment shown in FIG. 1.

FIG. 8 is a schematic diagram of a cover plate of the carrier module in FIG. 7 being opened.

FIG. 9 is a front view of the carrier module in FIG. 8.

FIG. 10 is a sectional view of the carrier module in FIG. 7.

FIG. 11 is a schematic structural diagram of a cleaning module of a corneal lens cleaning mechanism in another embodiment of the present disclosure.

FIG. 12 is a schematic structural diagram of a cleaning module of a corneal lens cleaning mechanism in yet another embodiment of the present disclosure.

### THE REFERENCE NUMERALS IN THE FIGURES ARE AS FOLLOWS

100, cleaning module; 101, support body; 1011, connecting groove; 1012, connecting ring; 1013, anti-rotation protrusion; 102, cleaning assembly; 1021, bristle portion; 1022, connecting portion; 1023, sleeve-type connecting portion;

200, carrier module; 201, basket; 202, cover plate; 203, handheld portion; 204, window; 205, connecting plate; 206, first connecting block; 207, second connecting block; 208, third connecting block; 209, fixing block; 210, protrusion; 211, extension portion; 212, connecting rod;

301, mounting plate; 302, transmission roller; 303, transmission block;

a, length of bristle portion; b, large cross-sectional diameter of bristle portion; c, small cross-sectional of bristle portion; d, distance between two adjacent bristle portions; e, height of support body; f, width of first through groove; g, distance between adjacent first through grooves; h, outer diameter of basket; i, inner diameter of basket; j, depth of basket; k, center distance between two adjacent baskets.

### DESCRIPTION OF EMBODIMENTS

Embodiments of the present disclosure will be described in more detail below with reference to the accompanying drawings. Although certain embodiments of the present disclosure are shown in the accompanying drawings, it should be understood that the present disclosure can be implemented in various forms and should not be construed as limited to the embodiments set forth herein. Rather, these embodiments are provided to bring a more thorough and complete understanding of the present disclosure. It should be understood that the accompanying drawings and embodiments of the present disclosure are only for illustrative purposes and are not intended to limit the scope of protection of the present disclosure.

In addition, it should also be noted that, for the convenience of description, only the parts related to the relevant invention are shown in the accompanying drawings. In the absence of conflict, the embodiments of the present disclosure and the features thereof may be combined with each other.

It should be noted that the concepts such as “first” and “second” mentioned in the present disclosure are only used to distinguish different devices, modules or units, and are not used to limit the order or interdependence of the functions performed by these devices, modules or units.

It should be noted that the modifications of “one” and “a plurality of” mentioned in the present disclosure are illustrative rather than restrictive, and those skilled in the art should understand that unless otherwise clearly indicated in the context, the modifications should be understood as “one or more”.

The names of messages or information exchanged between a plurality of devices in the implementations of the present disclosure are only used for illustrative purposes and are not used to limit the scope of these messages or information.

The present disclosure will be described in detail below with reference to the accompanying drawings and in conjunction with the embodiments.

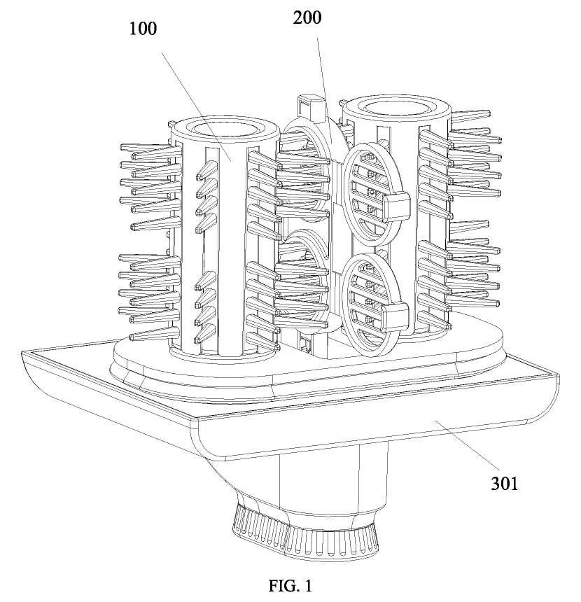

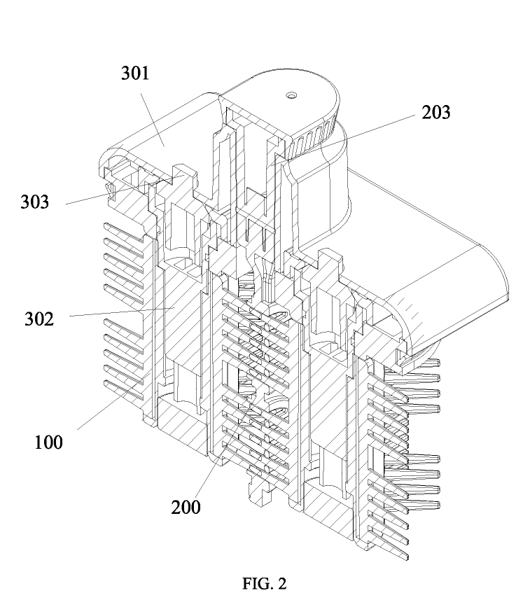

As shown in FIGS. 1 and 2, a corneal lens cleaning mechanism includes a carrier module 200 and a cleaning module 100.

Specifically, the cleaning module 100 includes a cleaning assembly 102 and a support body 101. The cleaning assembly 102 is connected to the support body 101 and configured to clean the corneal lens.

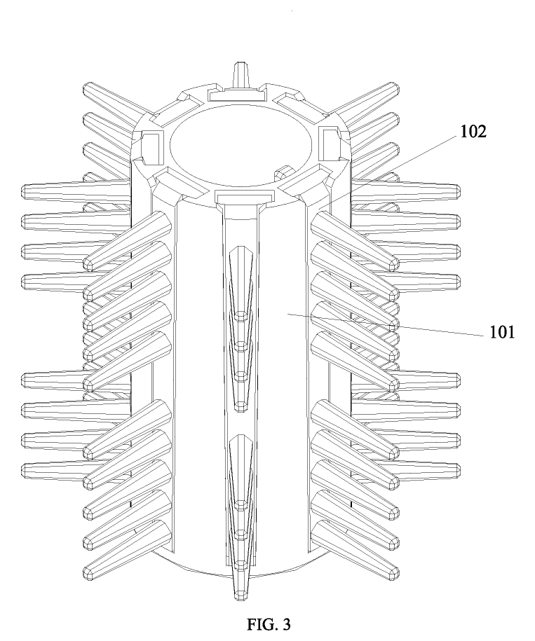

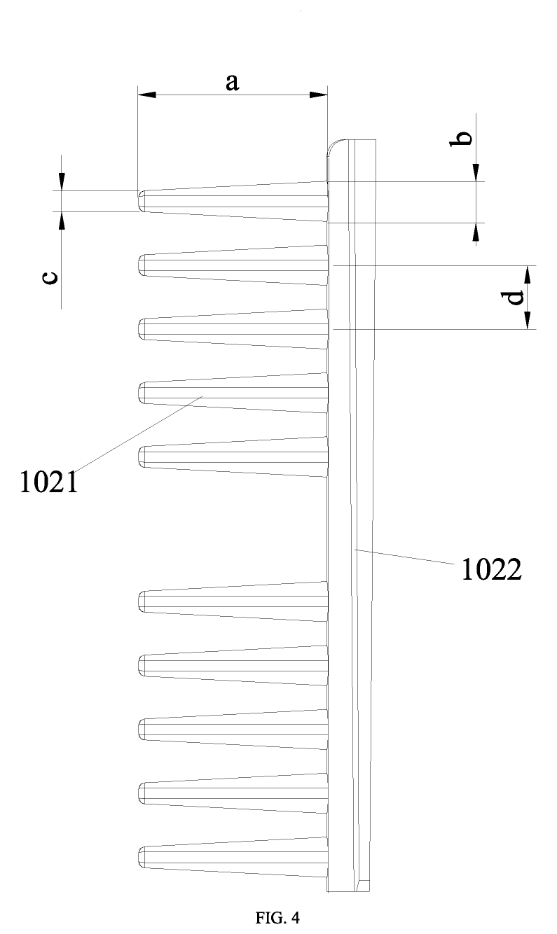

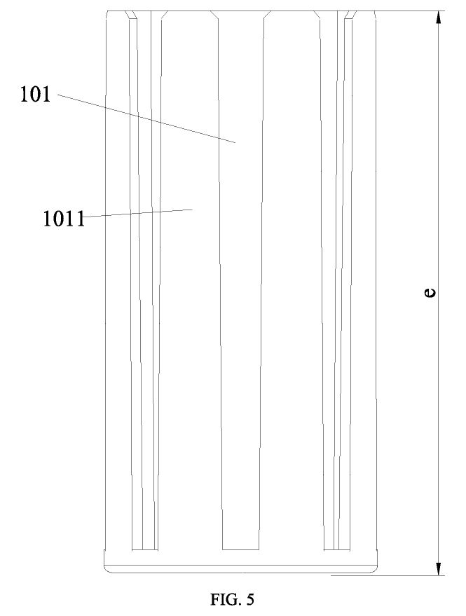

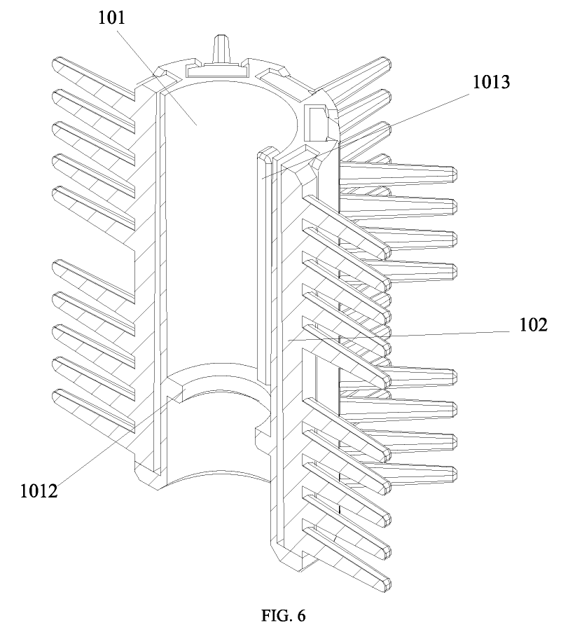

Specifically, as shown in FIGS. 3-6, the cleaning assembly 102 includes a plurality of bristle portions 1021 and a connecting portion 1022. The bristle portion 1021 and the connecting portion 1022 are each made of a flexible material. The connecting portion 1022 is connected to the support body 101. The hardness of the bristle portion 1021 is 40-70 degrees, preferably 50 degrees. The bristle portion 1021 and the connecting portion 1022 are integrally formed such that the bristle portion 1021 is fixedly connected to the connecting portion 1022.

More specifically, the bristle portion 1021 is of a tapered strip structure, that is, a cross-sectional area of the end of the bristle portion 1021 close to the connecting portion 1022 is greater than that of the end of the bristle portion 1021 away from the connecting portion 1022, enhancing the connecting effect between the bristle portion 1021 and the connecting portion 1022. Meanwhile, more bristle portions 1021 can come into contact with the lens by reducing the diameter of a contact end of the bristle portion 1021 and the lens, increasing the pressure exerted by each bristle portion 1021 on the lens and improving the wiping effect of the bristle portion 1021 on the lens. Due to the controlled hardness of the material of the bristle portion 1021, the desired cleaning effect is achieved without damaging the lens.

The bristle portion 1021 has a length of 5-15 mm. When cleaning different corneal lenses, such as OK lenses or scleral lenses, the length of the bristle portion 1021 is adjusted according to the actual size of the lens to accommodate a variety of corneal lenses with different diameters. The bristle portion 1021 has the maximum end diameter of 1-2.2 mm and the minimum end diameter of 0.5-1.2 mm. The size of the bristle portion 1021 is adjusted accordingly based on the types of corneal lenses being cleaned. When the bristle portion 1021 is in contact with the lens, one end of the bristle portion 1021 is bent, causing the side wall of the bristle portion 1021 to press against the surface of the lens. As the bristle portion 1021 moves relative to the lens, the side wall of the bristle portion 1021 wipes the surface of the lens to clean it. By setting the length of the bristle portion 1021, the contact area between the bristle portion 1021 and the lens is guaranteed, while avoiding excessive length of the bristle portion 1021 that could hinder the movement of the bristle portion 1021 itself. This improves the cleaning effect on the lens while ensuring the normal and stable operation of a cleaning tool.

As another preferred embodiment, the cross-sectional area of the end of the bristle portion 1021 close to the connecting portion 1022 is smaller than that of the end of the bristle portion 1021 away from the connecting portion 1022. By reducing the diameter of the connecting end of the bristle portion 1021 and the connecting portion 1022, the swing amplitude of bristles is larger, while also increasing the contact area of the cleaning end of the bristle portion 1021. The larger swing amplitude effectively removes proteins from the lens

Further, one connecting portion 1022 is provided with a plurality of bristle portions 1021. The bristle portions 1021 are evenly arranged on the connecting portion 1022 along a length direction of the connecting portion 1022, and a distance between adjacent bristle portions 1021 is 2.5-4 mm. Preferably, one bristle portion 1021 corresponds to eight lens for cleaning, which allows for the entire surface of the lens to be cleaned and wiped, ensuring that the lens is thoroughly cleaned.

The support body 101 is of a cylindrical rod structure, with a hollow middle portion that allows a transmission structure to be connected with the support body 101. This connection drives the support body 101 to rotate the cleaning assembly 102 around the central axis of the support body 101, achieving lens cleaning. The transmission structure can be a series of existing transmission methods such as motor transmission, cylinder transmission, and electric push rod transmission. The support body 101 is made of plastic, preferably medical-grade plastic. For cleaning an RGP lens or OK lens, the length is preferably 37 mm, and for cleaning a scleral lens, the length is preferably 57 mm. This ensures that the volume of a container holding a cleaning solution can be reduced when cleaning a pair of lenses, thereby reducing the waste of the cleaning solution and lowering the cost of lens cleaning per session.

A connecting ring 1012 and an anti-rotation protrusion 1013 are provided on the inner wall of the support body 101. The connecting ring 1012 is configured to form a connection with the transmission structure. The setting of the anti-rotation protrusion 1013 enables the support body 101 to rotate stably under the drive of the transmission structure, preventing slippage.

The corresponding number of cleaning assemblies 102 can be set as needed. It is preferably with eight bristle portions 1021 arranged on the support body 101, that is, a plurality of cleaning assemblies 102 are connected to the support body 101. The eight cleaning assemblies 102 are evenly arranged in a circular manner on the side wall of the support body 101. This arrangement, combed with the rotation of the support body 101, allows for multiple wiping and cleaning on the lens, greatly improving the cleaning effect on the lens.

Further, a connecting groove 1011 corresponding to the connecting portion 1022 is provided in the support body 101. The cross-section of the connecting portion 1022 perpendicular to the central axis of the support body 101 is of a T-shaped structure, and the cross-section of the connecting groove 1011 perpendicular to the central axis of the support body 101 is also of a T-shaped structure. The cleaning assembly 102 is connected to the support body 101 by embedding the connecting portion 1022 into the connecting groove 1011, which allows for quick replacement of partially damaged cleaning assemblies 102 as needed, and enables rapid adjustment of the number of bristle portions 1021 on the support body 101 according to requirements, thereby meeting a variety of different usage scenarios of the cleaning tool.

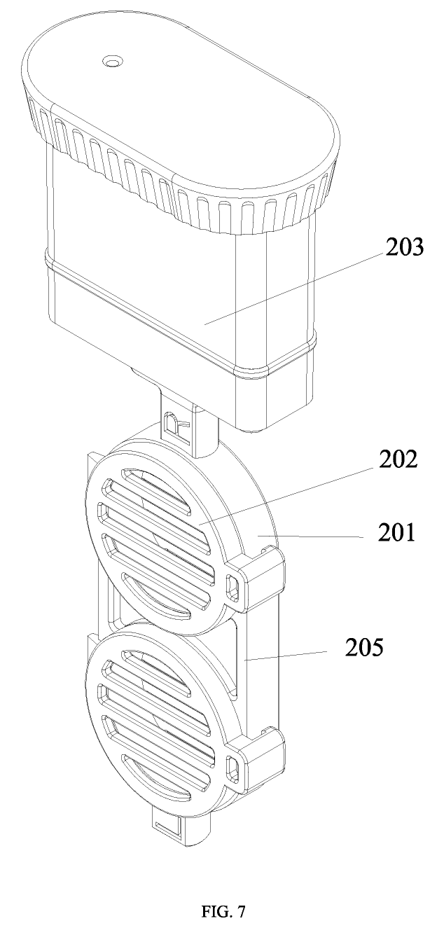

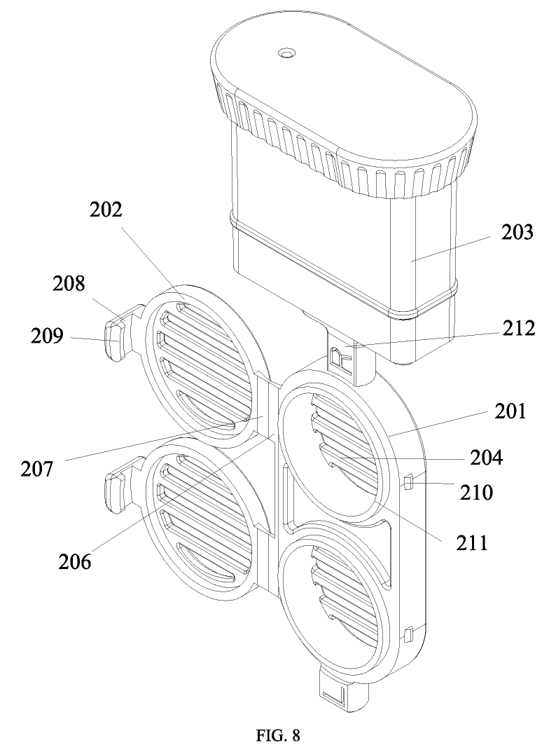

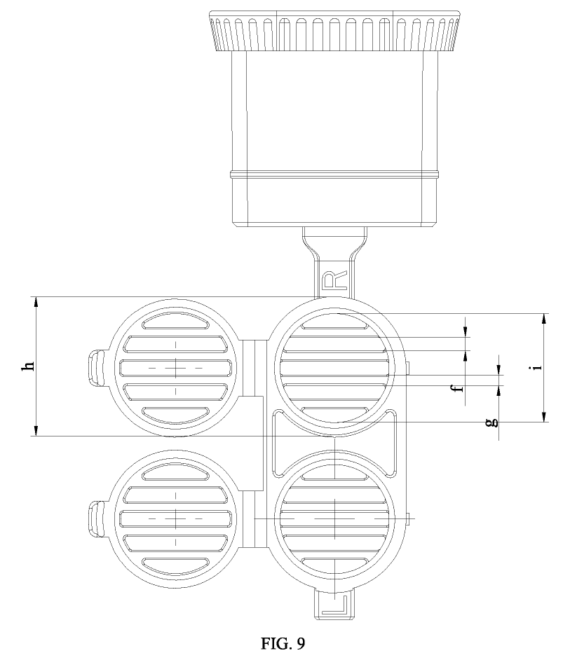

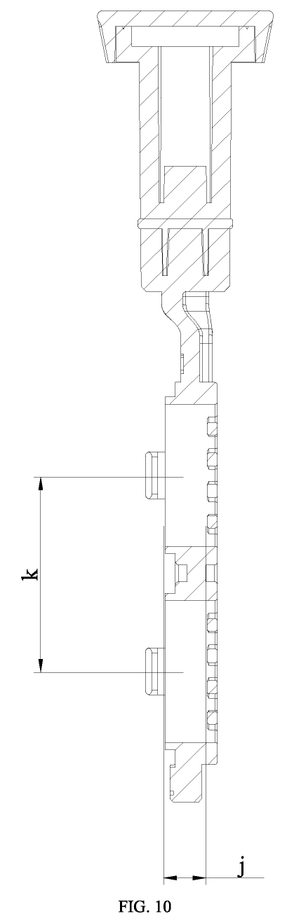

As shown in FIGS. 7-10, the carrier module 200 includes a plurality of baskets 201 and a cover plate 202. The basket 201 is constructed to have a basket structure for placing a corneal lens. A first connecting block 206 is provided on the side wall of the basket 201, and a second connecting block 207 is provided on the cover plate 202. The second connecting block 207 is rotatably connected to the first connecting block 206, achieving a rotational connection between the cover plate 202 and the basket 201. A third connecting block 208 is also provided on the side wall of the cover plate 202. A fixing block 209 is provided on the third connecting block 208 and has a slope. A protrusion 210 is provided on the side wall of the basket 201. When the cover plate 202 covers the basket 201, the third connecting block 208 presses against the side wall of the basket 201, and the fixing block 209 moves to one side of the protrusion 210, pressing against the side wall of the protrusion 210 to fix the cover plate 202 on the basket 201. The basket 201 and the cover plate 202 cooperate to form an accommodating space.

Two baskets 201 are provided and connected by a connecting plate 205. The baskets 201 are of circular structures, and the cover plate 202 is also of a circular structure accordingly. A connecting rod 212 is provided on the side wall of one of the baskets 201, and a handheld portion 203 is provided at one end of the connecting rod 212. The handheld portion 203 is of a rectangular structure, which is convenient for a user to handle the baskets. The handheld portion 203 is detachably connected to the connecting rod 212. Preferably, the connecting rod 212 is connected to the handheld portion 203 in a snap-fit connection manner, which is convenient for disassembly and assembly of the handheld portion 203.

Further, a plurality of windows 204 are provided in the basket 201 and the cover plate 202. Preferably, the windows 204 in the basket 201 and the windows 204 in the cover plate 202 are symmetrically arranged. In another embodiment, the windows 204 in the basket 201 and the windows 204 in the cover plate 202 may also be staggered, allowing the bristle portion 1021 to be inserted into the basket 201 from different positions to clean the lens, thereby ensuring the cleaning effect on the lens.

When the carrier module 200 and the cleaning module 100 are placed, the basket 201 and part of the bristle portions 1021 overlap, allowing the bristle portions 1021 to pass through the window 204 into the basket 201 to be in contact with the cornea lens for cleaning the cornea lens.

Specifically, the windows 204 are evenly arranged along the diameter direction of the basket 201. The window 204 has a width of 1-2.2 mm, and the basket 201 has a depth of 3-8.5 mm. This prevents the lens from falling out of the basket 201 or the cover plate 202 while providing a sufficient space for lens movement. As a result, when the bristle portion 1021 extends into the basket 201 through the windows 204 to be in contact with the corneal lens, the bristle portion 1021 pushes the corneal lens to move randomly in the basket 201, performing multi-axis vibration cleaning on the surface of the lens, and improving the cleaning effect on the lens. By setting the depth of the basket 201, they can accommodate RGP lenses and scleral lenses, avoiding the inner wall of the basket 201 and the cover plate 202 from pressing and damaging the lenses. The width of the windows 204 is set to be greater than the diameter of the cleaning end of the bristle portion 1021, allowing the bristle portion 1021 to directly extend into the basket 201 during rotating. The bristle portion 1021 can move randomly within a small range in the window 204, cleaning the lens from different positions and improving the cleaning effect on the lens.

Both ends of the windows 204 on the basket 201 extend to the side wall of the basket 201, and both ends of the windows 204 on the cover plate 202 extend to the side wall of the cover plate 202, such that the bristle portion 1021 can be in contact with the lens for a longer time, improving the cleaning effect on the lens. The side walls of the two windows 204 close to the side walls of the basket 201 are of arc-shaped structures, making the windows 204 correspond to the side walls of the basket 201.

The distance between two adjacent windows 204 is 2.5-4 mm. Preferably, five windows 204 are provided, and five corresponding bristle portions 1021 are also preferably provided. The spacing between two adjacent bristle portions 1021 corresponds to the distance between two adjacent windows 204, allowing the bristle portions 1021 to be fully inserted into the basket 201.

Further, when cleaning an RGP lens or an OK lens, the outer diameter of the basket 201 is 16-20 mm, and the inner diameter of the basket 201 is 12-16 mm. When cleaning a scleral lens, the outer diameter of the basket 201 is 20-31 mm, and the inner diameter of the basket 201 is 16-27 mm. The outer diameter of the cover plate 202 corresponds to the outer diameter of the basket 201, ensuring that the entire structure of the basket 201 has smooth side walls when the cover plate 202 covers on the basket 201. The setting of the inner and outer diameters of the basket 201 enables it to accommodate a variety of different types of corneal lenses, improving the applicability of the structure of the basket 201.

An extension portion 211 is provided on the basket 201 and is of a circular ring structure. When the cover plate 202 covers the basket 201, the extension portion 211 is located inside the cover plate 202. The cooperation between the extension portion 211 and the cover plate 202 improves the connecting effect between the cover plate 202 and the basket 201, preventing the cover plate 202 from opening during lens cleaning.

When cleaning an RGP lens or an OK lens, the center distance between the two baskets 201 is 17-20 mm. When cleaning a scleral lens, the center distance between the two baskets 201 is 20-32 mm. By limiting the distance between the two baskets 201, the overall length of the structure of the baskets 201 is reduced, thereby decreasing the size of the container holding the cleaning solution. This reduces the loss of the cleaning solution and lowers the cost of lens cleaning per session.

Preferably, the carrier module 200 is placed between two cleaning modules 100, and the bristle portions 1021 on the two cleaning modules 100 extend into the basket 201 through the window 204 of the basket 201 and the window 204 of the cover plate 202 respectively to be in contact with both sides of the corneal lens for cleaning the corneal lens, thereby improving the cleaning efficiency on the corneal lens.

The transmission structure is preferably a micro high-speed motor, such as HD7950 and 030 motors for driving. Meanwhile, eight groups of bristle structures are preferably provided and evenly arranged in a circular manner on the support body 101. The corneal lens is in contact and cleaned more than 20,000 times within 5 minutes. Meanwhile, as the bristle portion 1021 rotates, the cleaning solution is stirred, keeping the cleaning solution in a continuous flow state to rinse the surface of the corneal lens, thereby greatly improving the cleaning effect on the corneal lens.

In a specific embodiment, the cleaning module 100 is mounted on a mounting plate 301, A through groove for the basket 201 to pass through is formed in the mounting plate 301. The width of the handheld portion 203 is greater than the outer diameter of the basket 201. Therefore, when the basket 201 passes through the through groove, the handheld portion 203 presses against the side wall of the through groove, providing a support for the basket 201 and enabling the basket 201 to be located on one side of the cleaning module 100.

Specifically, a transmission roller 302 is provided on the mounting plate 301, and a transmission shaft passes through the support body 101. A limiting block is provided at one end of the transmission roller 302, and one end of the limiting block has a slope. When the transmission roller 302 is inserted into the support body 101, the limiting block presses against the connecting ring 1012, forming a connection fit between the transmission roller 302 and the support body 101. A protrusion is provided on the side wall of the transmission roller 302 and presses against the side wall of the anti-rotation protrusion 1013, forming a transmission fit between the transmission roller 302 and the support body 101. A transmission block 303 is provided at one end of the transmission roller 302, passes through the mounting plate 301 and is rotatably connected to the mounting plate 301. The transmission structure drives the transmission roller 302 to rotate by forming a transmission fit with the transmission block 303, thereby driving the cleaning module 100 to rotate for cleaning the corneal lens.

Using the cleaning mechanism to clean a corneal lens eliminates the need for manual cleaning of the corneal lens, freeing the user's hands, and avoiding bacterial infection problems caused by hand washing. The bristle portion 1021 replaces fingers in contacting the corneal lens, allowing multiple wipes of the lens in a short time, facilitating the cleaning of the entire lens, greatly improving the cleaning effect on the corneal lens, and avoiding damage to the corneal lens due to excessive force during cleaning.

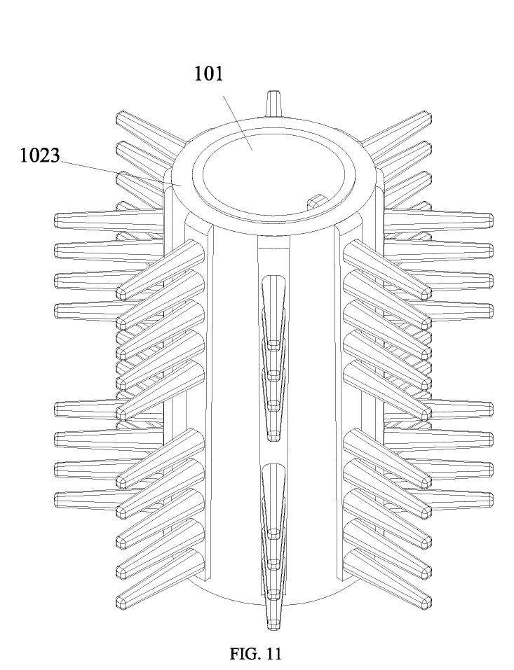

As a further preferred solution, as shown in FIG. 11, the connecting portion 1022 is of a sleeve-type structure. The cross-sectional diameter of the support body 101 is greater than the inner diameter of the sleeve-type connecting portion 1023, and the connecting portion is connected to the support body 101 in a sleeving manner, making the installation of the bristle structure more convenient and quicker. By setting the diameter and the inner diameter of the support body 101 and the connecting portion 1022, the connecting portion 1022 is interference fitted onto the support body 101, ensuring the connecting effect between the support body 101 and the connecting portion 1022. The use of the sleeve-type connecting portion 1023 prevents the cleaning solution from entering the connecting groove 1011 during lens cleaning, eliminating cleaning dead spots, and further improving the hygiene of the cleaning tool.

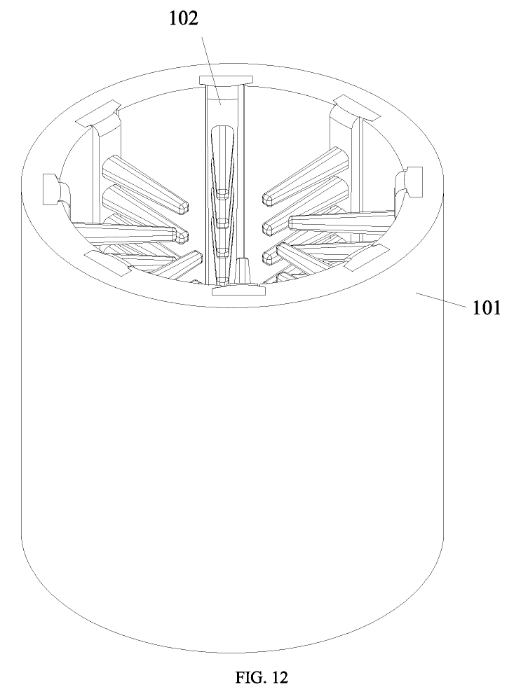

As another preferred solution, as shown in FIG. 12, a cavity for accommodating the corneal lens is formed in the hollow structure in the middle of the support body 101, and the bristle structure is connected to the inner wall of the support body 101. When cleaning the lens, it is placed in the support body 101, and the support body 101 is driven to rotate, allowing the bristle portion 1021 to be in contact with the lens for cleaning the lens. By directly designing the middle portion of the support body 101 as a lens cleaning cavity, the volume of a liquid storage container is greatly reduced, minimizing the waste of the cleaning solution and effectively reducing the cost of lens cleaning per session, thereby meeting the daily usage needs of customers.

The above description is merely an illustration of some preferred embodiments of the present disclosure and the technical principles applied. Those skilled in the art should understand that the scope of inventions involved in the embodiments of the present disclosure is not limited to the technical solutions formed by the specific combination of the above-mentioned technical features, but should also cover other technical solutions formed by any combination of the above-mentioned technical features or their equivalent features without departing from the above-mentioned inventive concept. For example, technical solutions formed by interchanging the above-mentioned features with technical features disclosed in the embodiments of the present disclosure and having similar functions (but not limited thereto) are also encompassed.

What is claimed is:

1. A corneal lens cleaning mechanism, comprising:
a carrier module, configured to place a corneal lens; and
a cleaning module, in contact with the corneal lens for cleaning the corneal lens; wherein
the carrier module is provided with a plurality of windows for the cleaning module to pass through, and the carrier module and the cleaning module at least partially overlap during a cleaning process, allowing the cleaning module to pass through the windows into the carrier module to be in contact with the corneal lens;
the cleaning module is movable relative to the carrier module; when moving, the cleaning module pushes the corneal lens to move in the carrier module, and meanwhile, the cleaning module moves relative to the corneal lens to wipe and clean the surface of the corneal lens.

2. The corneal lens cleaning mechanism according to claim 1, wherein the carrier module comprises:
a plurality of baskets, each configured to have a basket structure for placing the corneal lens; and
a cover plate, covering the basket to form an accommodating space in the basket; wherein
the windows are provided in the basket and the cover plate, to form a plurality of openings for the cleaning module to extend into in side walls of the accommodating space.

3. The corneal lens cleaning mechanism according to claim 1, wherein the cleaning module comprises:
at least one cleaning assembly, configured to clean the corneal lens; and
a support body, configured to install the cleaning assembly; wherein
the cleaning assembly comprises a plurality of bristle portions and a connecting portion, and the bristle portions are connected to the connecting portion;
the bristle portions are each made of a flexible material such that the bristle portion bends when in contact with the cornea lens, allowing a side wall of the bristle portion to be in contact with the cornea lens to clean the cornea lens; and
the connecting portion is made of a flexible material and is connected to the support body.

4. The corneal lens cleaning mechanism according to claim 3, wherein the bristle portion is of an elongated structure and has a length of 5-15 mm.

5. The corneal lens cleaning mechanism according to claim 3, wherein a cross-sectional area of one end of the bristle portion perpendicular to a length direction of the bristle portion is greater than a cross-sectional area of the other end of the bristle portion perpendicular to the length direction of the bristle portion.

6. The corneal lens cleaning mechanism according to claim 5, wherein a cross-sectional diameter of the one end of the bristle portion perpendicular to the length direction of the bristle portion is 1-2.2 mm, and a cross-sectional diameter of the other end of the bristle portion perpendicular to the length direction of the bristle portion is 0.5-1.2 mm.

7. The corneal lens cleaning mechanism according to claim 3, wherein the bristle portions are evenly arranged on the connecting portion along a length direction of the connecting portion, and a distance between adjacent bristle portions is 2.5-4 mm.

8. The corneal lens cleaning mechanism according to claim 2, wherein the window has a width of 1-2.2 mm.

9. The corneal lens cleaning mechanism according to claim 2, wherein the windows are evenly arranged along a side wall of the basket or the cover plate, and a distance between two adjacent windows is 2.5-4 mm.

10. The corneal lens cleaning mechanism according to claim 2, wherein the basket has a depth of 3-8.5 mm.
